(19) United States
(12) Patent Application Publication
(10) Pub. No.: US 2022/0066188 A1
(43) Pub. Date: Mar. 3, 2022

(54) Method and Apparatus for Light Sheet Microscopy and Method and Apparatus for Varying an Intensity of Illumination Light

(71) Applicant: Carl Zeiss Microscopy GmbH, Jena (DE)

(72) Inventors: Jörg Siebenmorgen, Jena (DE); Thomas Kalkbrenner, Jena (DE)

(21) Appl. No.: 17/412,586

(22) Filed: Aug. 26, 2021

(30) Foreign Application Priority Data
Aug. 31, 2020 (DE) 10 2020 122 726.4

(51) Int. Cl. G02B 21/14; G02B 21/00

(52) U.S. Cl. CPC G02B 21/14; G02B 21/002

(57) ABSTRACT

The invention relates to a method and an apparatus for light sheet microscopy, in which a sample is illuminated with a light sheet and is observed with a microscope, wherein illumination light is shaped to form the light sheet using a controllable phase mask, wherein the controllable phase mask is controlled to form a phase pattern in which at least first regions and second regions are arranged in alternation, wherein a greater phase angle deviation is impressed on the illumination light in the first regions than in the second regions, and wherein at least the phase angle deviation of the first regions is controlled in a spatially dependent manner for influencing the intensity of the illumination light at different locations of a cross-sectional area of the light sheet. The invention additionally relates to a method and an apparatus for providing illumination light with variable intensity.

### REFERENCE TO RELATED APPLICATIONS

The current application claims the benefit of German Patent Application No. 10 2020 122 726.4, filed on 31 Aug. 2020, which is hereby incorporated by reference.

### TECHNICAL FIELD

The invention described herein relates in a first aspect to a method and to an apparatus for light sheet microscopy according to the preamble of claims 1 and 13, respectively. In a second aspect, the invention relates to a method and to an apparatus for varying an intensity of illumination light, in particular for microscopy.

### BACKGROUND ART

A generic method for light sheet microscopy is described, for example, in DE 10 2017 223 014 A1.

In this generic method for light sheet microscopy, a sample is illuminated with a light sheet and observed using a microscope. Using a controllable phase mask, illumination light is here shaped into the light sheet, wherein the controllable phase mask is controlled to form a phase pattern in which at least first regions and second regions are arranged in alternation, and wherein a greater phase angle deviation is impressed onto the illumination light in the first regions than in the second regions.

A generic apparatus for light sheet microscopy is likewise disclosed in DE 10 2017 223 014 A1.

This generic apparatus for light sheet microscopy has the following components: a light source for providing illumination light, a controllable phase mask and further optical components for shaping the light sheet, optical components, in particular an objective, for guiding the light sheet into a sample, a microscope for observing the sample, and a control device for controlling the phase mask.

For generating a light sheet, that is to say a light beam having substantially the shape of a flat strip, cylindrical optical units are used in the prior art. The radiation sources used furthermore typically have a Gaussian profile. The starting point for producing the light sheet is therefore generally a laser beam having an elliptical Gaussian profile. The result of this is that the illumination intensity in the light sheet becomes darker towards the periphery, which naturally affects the observation of the region illuminated with the light sheet with a microscope, typically with a fluorescence microscope. At the centre of the light sheet, the excitation of fluorescence light is stronger, whereas it becomes weaker towards the periphery owing to the intensity profile of the illumination. This effect is also present in principle if a phase mask is used for further shaping the light sheet, because the phase mask is exposed to exactly the aforementioned elliptical Gaussian beam profile.

It is known in the prior art to convert a light beam with a Gaussian intensity distribution into a light beam having a substantially homogeneous intensity distribution using what are known as Powell lenses. But since the phase fronts downstream of the phase mask are no longer plane, Powell lenses cannot be used together with phase masks.

In a further solution for spatially homogenizing an intensity distribution of the illumination light known in the prior art, a glass plate with inhomogeneous transmission, for example a glass plate with an inhomogeneous coating, for example with chromium, is positioned in front of the phase mask. This solution is inflexible with regard to the manipulation of the intensity profile.

Finally, it is known to use a phase plate for homogenizing the intensity distribution. This is also not possible in conjunction with a phase mask because the phase fronts are no longer plane.

### SUMMARY OF THE INVENTION

A general problem in the field of microscopy is also that of suitably adapting the intensity of an illumination light source to the respective situation. In this case, it must be taken into account that the laser intensities being used can vary over many orders of magnitude. For example, very high intensities are used for experiments with photo switches, such as FRAP, PAINT, whereas lower intensities are used for normal fluorescence microscopy. It is known in the prior art to vary the intensity of a laser source in principle continuously with the aid of an AOTF, which is connected downstream. However, increasingly, lasers that can be modulated directly in terms of their intensity are used. While this is continuous per se, it is possible only with a limited dynamic range. Yet this means that such light sources can no longer be regulated sufficiently finely for normal use in fluorescence microscopy. In these situations, acousto-optical elements and/or interchangeable different attenuation (neutral density filters) can be introduced into the beam path. However, this is undesirable due to the mechanical-technical complexity and the costs.

A first object of the invention can be considered that of creating a method and an apparatus for light sheet microscopy in which the acquired images have the most homogeneous brightness possible.

It is a second object of the invention to specify a method and an apparatus for varying the intensity of an illumination light source in which the previously described drawbacks of the prior art are avoided.

The first object is achieved by the method having the features of claim 1 and by the apparatus having the features of claim 13.

The second object is achieved by the method having the features of claim 2 and by the apparatus having the features of claim 14.

The method for light sheet microscopy of the type stated above is further developed according to the invention in that at least the phase angle deviation of the first regions is controlled in a spatially dependent manner for influencing, in particular for homogenizing, the intensity of the illumination light at different locations of a cross-sectional area of the light sheet.

The apparatus for light sheet microscopy of the type stated above is further developed according to the invention in that the control device is configured for controlling the phase mask according to the method for light sheet microscopy according to the invention.

In the method for varying an intensity of illumination light according to the invention, illumination light is guided over a controllable phase mask, wherein the controllable phase mask is controlled to form a phase pattern in which first regions and second regions are arranged in alternation, and wherein a greater phase angle deviation is impressed onto the illumination light in the first regions than in the second regions. For varying a desired intensity of the illumination light downstream of the controllable phase mask, at least the phase angle deviation of the first regions is then controlled depending on the desired intensity.

The apparatus for providing illumination light with variable intensity according to the invention has a light source for providing illumination light and a controllable phase mask and a control unit for controlling the phase mask. The control unit is configured according to the invention for controlling the phase mask according to the method for varying an intensity of illumination light according to the invention.

Advantageous configurations of the method according to the invention and preferred exemplary embodiments of the apparatuses according to the invention are described below, in particular in connection with the dependent claims and the figures.

The microscope for observing the sample, in particular for observing the region of the sample that is illuminated with the light sheet, can, in principle, be any microscope in which light is used for the contrasting principle, in particular the microscope can be a laser scanning microscope or a widefield microscope.

The term illumination light refers to any electromagnetic radiation that is used for generating or exciting a contrasting effect for microscopy. In particular, the term illumination light refers to excitation radiation for conventional fluorescence microscopy or 2-photon or multiphoton microscopy. This may be electromagnetic radiation in the visible but also in the infrared or UV ranges.

The term desired intensity of the illumination light refers to the intensity that must be provided by an apparatus for providing illumination light. For example, this may be a maximum intensity in a light beam, for example having a Gaussian profile.

The light sheet can be generated both statically, for example with the aid of cylindrical lenses, or quasi-statically, by virtue of the sample being scanned quickly in one plane by means of a light beam with the aid of a scanner. The light sheet-type illumination arises when the light beam undergoes a very fast relative movement with respect to the sample under observation, which is repeated multiple times in temporal succession so as to line up.

The term controllable phase mask refers to a substantially two-dimensional device with which a specific phase angle deviation is impressed on electromagnetic radiation that is reflected by said phase mask or that passes through said phase mask. It is important that this phase angle deviation can be set, that is to say is controllable, specifically depending on the location in the plane of the phase mask at which the electromagnetic radiation is reflected or transmitted. The controllable phase mask can also be referred to as a controllable two-dimensional or 2D phase mask.

The phase mask can be, for example, a 2D phase mask with rows and columns of pixels. Typically, a nematic or ferroelectric spatial light modulator (SLM) can be used as the phase mask.

The term phase angle deviation refers to the difference in the phase of the electromagnetic radiation that is impressed on the electromagnetic radiation upon reflection at or upon transmission through the phase mask. The phase angle deviation can also be referred to as phase shift or phase difference. It is important that the phase angle deviation generally is a function of the location on the phase mask.

Phase pattern refers to a specific spatially dependent control of the controllable phase mask at a specific point in time, that is to say in principle an assignment of a specific phase angle deviation to a location in the plane of the phase mask.

The terms first region and second region in each case refer to the two-dimensional connected regions in the plane of the phase mask. What is essential to the invention is that the phase patterns in each case have a plurality of first regions and a plurality of second regions and that the phase pattern is characterized by the spatially alternating arrangement of said first regions and second regions.

For realizing the invention, it is sufficient if first regions and second regions are present. However, it is also possible that further, for example third and fourth, regions are present, in which the phase angle deviation is different in each case compared to the first and second regions.

The first regions, the second regions, and where appropriate further regions can be implemented in particular in each case by individual pixels or in each case by a plurality of pixels of the phase mask.

For realizing the feature of being arranged in alternation, it is sufficient that the phase pattern that the phase mask is controlled to form is characterized by a sequence of at least first and second regions. However, it is also possible that further, for example third and fourth, regions, in which the phase angle deviation is different in each case compared to the first and second regions, are present between the first and second regions.

Guiding light over a phase mask is understood to mean that the light is in each case either reflected at the phase mask or passes through the phase mask.

In principle, known devices, for example a PC or similar programmable devices, such as microcontrollers, can be used as the control device for controlling the phase mask.

The control device can also serve for controlling other microscope components and for evaluating data, for example data of a camera with which microscope images are recorded.

It can be considered an essential concept of the present invention that the possibilities of controllable phase masks are exploited for use in the field of microscopy, in particular light sheet microscopy, with respect to the setting of intensity profiles of light beams.

It is an important advantage of the present invention that the manipulation of the intensity profile of a light sheet is possible by using a component that is already present, to be precise for shaping the light sheet. Since no mechanical adaptations need to be carried out, cost advantages can be achieved.

With respect to the manipulation and setting of a desired intensity in the case of an illumination light source, it is likewise especially advantageous that an intensity can in principle be adjusted continuously and that no mechanical manipulations must be carried out for changing an intensity.

The solutions according to the invention can be used with particular advantage where a phase mask for shaping an illumination beam is already used. Examples of this are methods and apparatuses for producing a light sheet using a phase mask. In particular, a phase mask can be used to generate what are known as sinc3 light sheets (see DE 10 2012 013 163 A1), coherent Bessel beams or lattice light sheets, light sheets produced based on Mathieu beams or Bessel beams, or light sheets produced with the aid of lattices, as is described for example in US 2013/286181 A1.

In principle, the present application separately claims the solutions of setting an intensity profile in a cross-sectional area of a light sheet (claims 1 and 13) and setting a desired intensity of illumination light (claims 2 and 14). Both solutions have in common that the illumination light is guided over a phase mask, that the illumination light is consequently reflected at the phase mask or passes through the phase mask, and that the phase mask is controlled in a targeted manner for achieving the desired manipulation, be it with respect to the intensity profile in a cross-sectional area of the light sheet or with respect to a desired intensity.

It is important that the solution according to the invention with respect to the setting of a desired intensity of the illumination light can also be combined with the manipulation of the intensity profile of a light sheet. A particularly preferred variant of the method for light sheet microscopy according to the invention is therefore characterized in that, for varying a desired intensity of the illumination light downstream of the controllable phase mask, at least the phase angle deviation of the first regions is controlled in dependence on the desired intensity as well.

In a particularly preferred variant of the phase pattern, the phase angle deviation of the first regions is comparatively large, in particular greater than π/2, and the phase angle deviation of the second regions is comparatively small, in particular less than π/2.

In principle, it is possible that both the phase angle deviation of the first regions and also the phase angle deviation of the second regions is controlled in a spatially dependent manner. In a preferred variant, however, only the phase angle deviation of the first regions is controlled in a spatially dependent manner and the phase angle deviation of the second regions remains constant. In particular, the phase angle deviation of the second regions can correspond to a minimal phase angle deviation, which can be realized by way of the controllable phase mask.

For realizing the invention, it is important that in each case a plurality of first regions and a plurality of second regions are present in the phase pattern. For example, the first regions and the second regions can be arranged in a spatially alternating manner in the phase pattern and can in particular be arranged in a chequerboard-like manner. Chequerboard-like should here also apply if the individual regions in each case have a rectangular shape. The size of the rectangles can here in one and the same phase pattern be the same everywhere. However, it is also possible that these rectangles in one and the same phase pattern have different sizes.

For light sheet microscopy, the controllable phase mask expediently has the shape of a long rectangle and the spatially dependent phase deviation angle in particular along a direction of the longer side of the rectangle relative to the centre can be a symmetric function. The phase pattern that the controllable phase mask is controlled to form can be periodic in at least one spatial direction, in particular in the spatial direction corresponding to the shorter side of the rectangle.

In principle, the invention makes it possible in a light sheet to set a specific desired intensity profile over the cross-sectional area thereof. In a particularly important variant of the method according to the invention, this is done in a manner such that the phase angle deviation of the first regions is set in a spatially dependent manner such that the intensity of the illumination light is substantially constant over a cross-sectional area of the light sheet.

A substantially constant intensity profile over a cross-sectional area of the light sheet can be attained for example if the phase pattern is controlled such that the spatially dependent phase angle deviation φ(x) of the first regions is given by

φ(x)=φ₀(1−I(x)/Iₘₐₓ).

Here, φ(x) denotes the phase angle deviation to which a first region of the phase mask should be controlled at the location x of the phase mask, φ₀ is a specific fixed phase angle deviation, for example the maximum phase angle deviation that can be implemented with the phase mask, I(x) is the profile of the intensity of the illumination light in the plane of the phase mask at the location x, and Iₘₐₓ is the maximum intensity of the illumination light in the plane of the phase mask. By selecting the value φ₀, the maximum intensity can be determined.

The significant advantage of the invention that any intensity profile in a light sheet over the cross-sectional area thereof can in principle be set, however, makes even further advantageous configurations possible. For example, it is possible with the method for light sheet microscopy according to the invention to compensate any vignetting of a detection objective, which results in the brightness of the image decreasing as the distance from the optical axis of the detection objective increases even in the case of homogeneous illumination by way of the light sheet.

In this variant of the method, the phase angle deviation of the first regions is set in a spatially dependent manner such that the intensity of the illumination light in the cross-sectional area of the light sheet appropriately increases with the distance from the optical axis of an observation optical unit. Specifically, the intensity profile can be adapted quantitatively to the vignetting of the detection objective.

With particular preference, a laser having a settable intensity is used as the light source. The changing of the intensity with the phase mask can then serve for coarsely setting the intensity, and the intensity is finely set via the intensity setting of the laser. The phase mask can thus replace a device for coarsely setting the intensity of the illumination light, such as a filter wheel having various attenuators.

### BRIEF DESCRIPTION OF THE DRAWINGS

Further advantages and features of the invention are explained below in connection with the figures.

FIG. 1 shows a schematic illustration of an apparatus for light sheet microscopy from the prior art;

FIG. 2 shows a schematic illustration of an illumination unit having a controllable phase mask;

FIGS. 3 to 6 show schematic diagrams for explaining the starting problem of the invention;

FIG. 7 shows diagrams (a), (b), (c) and (d) from the prior art for explaining the effect of controllable phase masks;

FIGS. 8 to 10 show schematic diagrams of the phase mask for explaining the method for light sheet microscopy according to the invention;

FIG. 11 shows a further diagram for explaining the method for light sheet microscopy according to the invention;

FIG. 12 shows a schematic illustration of an apparatus for varying illumination light according to the prior art;

FIG. 13 shows an exemplary embodiment of an apparatus for varying illumination light according to the invention.

Identical and identically acting components are generally identified by the same reference signs in the figures.

### DETAILED DESCRIPTION OF THE INVENTION

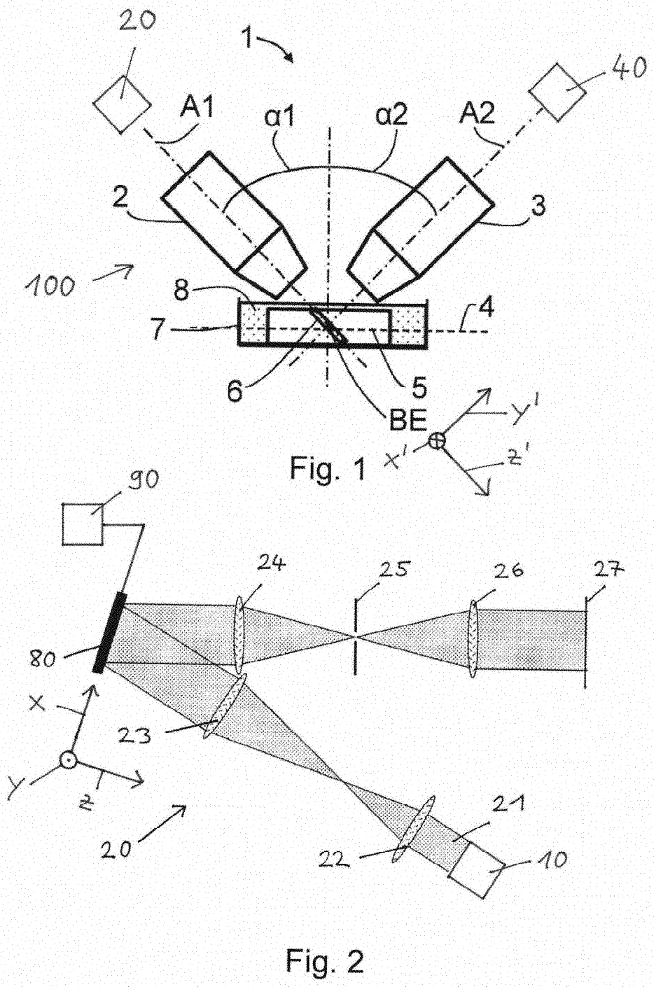

The construction of a generic apparatus 100 for light sheet microscopy (SPIM construction; single plane illumination microscopy) is explained in conjunction with FIGS. 1 and 2. This apparatus 100 initially includes, as essential components, an illumination and beam shaping unit 20, an illumination objective 2 for guiding the light sheet into a sample 5, and a microscope, implemented by a detection objective 3 having a camera unit 40 arranged downstream, for observing the sample 5.

The illumination and beam shaping unit 20, the details of which will be described in more detail below, has, as essential components, a light source 10 for providing illumination light 21 and a controllable phase mask 80 and further optical components 22-26 for shaping a light sheet 6. The light sheet 6 is guided into the sample 5 using the illumination objective 2.

A1 denotes the optical axis of the illumination objective 2 and A2 denotes the optical axis of the detection objective 3. A1 and A2 together enclose a right angle and are oriented in each case at an angle of 45° relative to a surface normal of the sample plane 4. The sample 5 arranged in the sample plane 4 is situated, for example, on the base of a sample vessel 7 embodied as a petri dish. The sample vessel 7 can be filled with a liquid 8, for example water, and the two objectives 2, 3 can be immersed in the liquid 8 during the application of the light sheet microscopy (not shown). The light sheet 6 extends in an x′-y′-plane spanned by the x′-axis and the y′-axis of a Cartesian coordinate system x′, y′, z′. The optical axes A1 and A2 lie in the y′-z′-plane, that is to say the x′-axis is perpendicular to the axes A1 and A2. An observation plane BE is defined by the plane of the light sheet 6.

Alternatively, the two objectives 2, 3 can be directed into the sample plane 4, while maintaining the 45° configuration, in an inverted arrangement from below through a transparent base of the sample vessel 7. For further details in this respect and for further details relating to the construction of FIG. 1, reference is made to DE 10 2017 223 014 A1.

The construction of the illumination and beam shaping unit 20 with further details is illustrated in FIG. 2. The light 21, which is coming from a light source 10, in particular a laser 10, and can have in particular a Gaussian beam profile, is first incident on a first cylindrical lens 22, which, together with a second cylindrical lens 23, forms a first telescope. A controllable phase mask 80, in particular a nematic SLM, is arranged in a collimated part of the beam path. For controlling the phase mask 80 to form different phase patterns, a control unit 90, for example a microcontroller and/or a PC, is present. After reflection at the phase mask 80, the light finally passes via a fourth lens 24 and a fifth lens 26, which form a second telescope, to the exit plane 27. A stop 25 is located between the third lens 24 and the fourth lens 26. The stop 25 can in particular be a stop in the shape of a circular disc, with which only the zero order of diffraction in the central region of the beam profile is blocked. In an alternative variant, the stop is a pinhole, which only allows the zero order of diffraction through. The phase mask is arranged in a plane that is optically conjugate to the exit plane 27. For the exemplary embodiment illustrated in FIG. 1, this is here preferably a plane that is optically conjugate to the focal plane of the illumination objective 2.

The apparatus 100 shown in FIG. 1 becomes, together with the illumination and beam shaping unit 20 illustrated in FIG. 2, an exemplary embodiment of the apparatus for light sheet microscopy according to the invention if additionally the feature according to the invention that the control device 90 is configured for controlling the phase mask 80 according to the method for light sheet microscopy according to the invention is realized.

The illumination and beam shaping unit 20 illustrated in FIG. 2 becomes an exemplary embodiment of the apparatus for providing illumination light with variable intensity according to the invention if additionally the feature according to the invention that the control device 90 is configured for controlling the phase mask 80 according to the method for varying an intensity of illumination light according to the invention is realized.

The method for light sheet microscopy according to the invention and the method for varying an intensity of illumination light according to the invention will be described below.

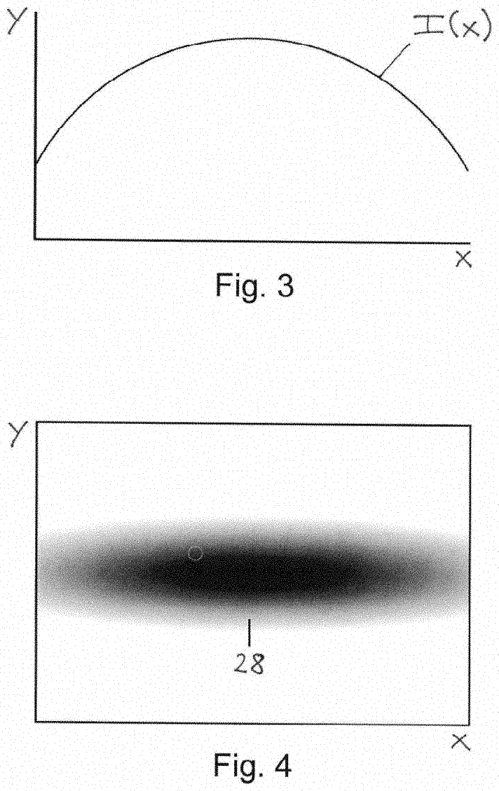

The starting point of the invention and the technical problem are once again explained in conjunction with FIGS. 3 to 7.

In a light sheet microscope, the sample is excited using a light sheet and the fluorescence is detected. In this case, vignetting of the image induced by the light sheet may occur. That means that, in deviation from an ideal situation in which the image of a sample appears uniformly bright over the entire field of view, what is known as vignetting causes the image of a sample to be bright at the centre of the field of view but to become increasingly darker in the direction of the peripheries.

This decrease in brightness in the direction of the image peripheries is at least in part due to the intensity distribution in a cross section of the light sheet perpendicular to the optical axis of the illumination objective. This intensity distribution is not constant but decreases in the direction of the peripheries. This is illustrated schematically in FIG. 3, where the intensity I(x′) of the light in a cross-sectional area of the light sheet (vertical axis) is plotted against the coordinate x′ of FIG. 1 (horizontal axis). As is clear, the intensity I(x′) in the centre of the light sheet is at a maximum and decreases in the direction of the peripheries.

The main reason for this intensity distribution I(x′) is that the light coming from a light source 10, in particular from a laser, generally has a Gaussian intensity distribution, which is only elliptically distorted by cylindrical lenses, for example the cylindrical lenses 22, 23 in FIG. 2. That means that the controllable phase mask 80 is illuminated with an elliptical Gaussian intensity profile. This will be explained in detail in connection with FIGS. 4 to 6. The xy-coordinate system used in FIGS. 4 to 6 corresponds to the xyz-coordinate system shown in FIG. 2, that is to say the z-axis is perpendicular to the plane of the paper in FIGS. 4 to 6.

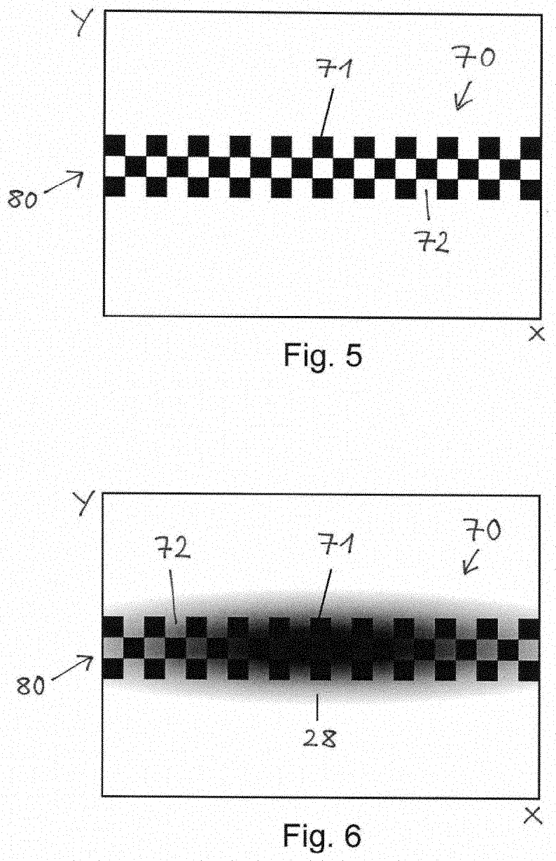

The elliptical Gaussian intensity profile is illustrated schematically as a cloud 28 in FIG. 4. FIG. 5 schematically shows a phase mask 80, for example a nematic spatial light modulator SLM having 3 rows and 21 columns. The phase mask 80 has a rectangular shape, wherein the x-axis extends in the direction of the long side of the rectangle. That means that the long side of the phase mask 80 lies in the image plane in FIG. 2. In the example shown in FIG. 5, the phase mask 80 is controlled to form a chequerboard-like phase pattern 70 having first regions 71 and second regions 72 which in each case have the same size. Each of the first regions 71 and of the second regions 72 in the example shown consists of a plurality of pixels of the SLM. The phase angle deviation in the second regions 72 can, for example, correspond to the phase angle deviation that is able to be realized minimally by the phase mask 80, that is to say it can be substantially 0, and the phase angle deviation in the first regions 71 can be, for example, π. FIG. 6 schematically illustrates the illumination of the phase mask 80 with the elliptical Gaussian intensity profile 28 of the illumination light from FIG. 4.

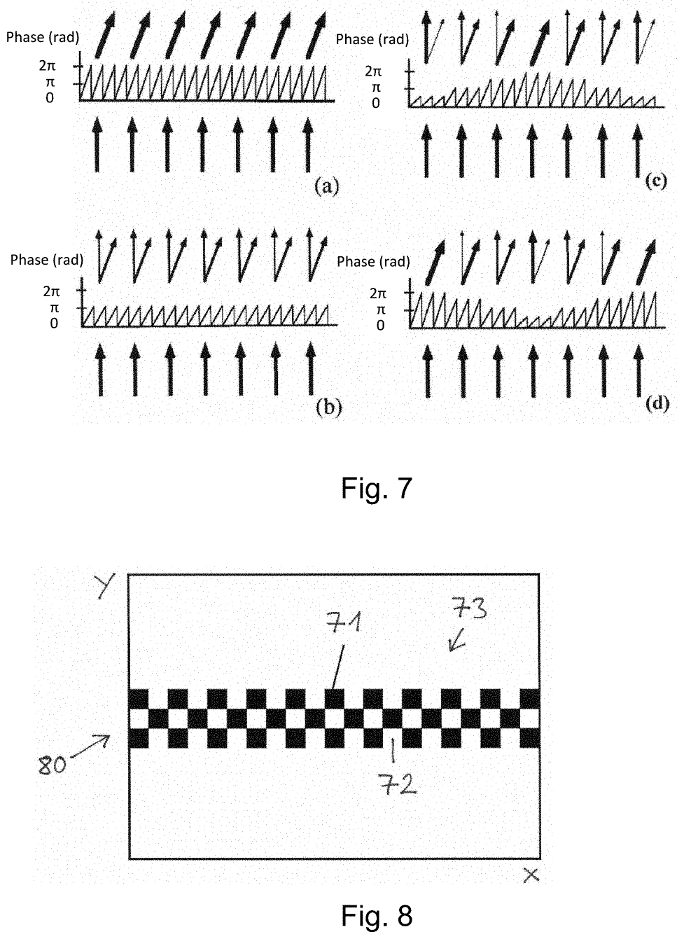

FIG. 7 shows a depiction from Davis et al.: “Encoding amplitude information onto phase-only filters”, Applied Optics Vol. 38, Issue 23, pp. 5004-5013 (1999). In that paper, the manipulation of intensity profiles with phase masks is examined. The phase masks examined there in each case have a sawtooth-like profile of the phase angle deviation. In FIGS. 7a) to 7d), in each case the phase angle deviation of the phase mask is plotted (in rad, vertical axis) against a spatial coordinate of the phase mask (horizontal axis). In FIGS. 7a) to 7d), the light is in each case incident substantially orthogonally on the phase mask, illustrated in each case by a plurality of arrows, which come from the bottom and point vertically upwards, below the respective diagrams. Light that passes through the phase mask in the zero order of diffraction, that is to say without diffraction, is illustrated in FIGS. 7a) to 7d) by arrows, which vertically point upwards, above the respective diagrams.

Light that passes through the phase mask in the first order of diffraction is illustrated in FIGS. 7a) to 7d) by arrows, which point obliquely to the top right, above the respective diagrams. The thickness of the arrows above the diagrams indicates in each case the intensities of the light beams.

In the situation in FIG. 7a), the amplitude of the sawtooth-like profile of the phase angle deviation is 2π everywhere. It thus shows that 100% of the light that is used to irradiate the phase mask are deflected in the first order of diffraction. The diffraction efficiency in FIG. 7a) is thus at a maximum.

FIG. 7b) shows a situation in which the amplitude of the sawtooth-like profile of the phase angle deviation is constant but is only half that shown in FIG. 7a), that is to say is π. The result is that the light with which the phase mask is irradiated is transferred everywhere to approximately identical parts into the first and zero orders of diffraction.

FIG. 7c) now shows a situation in which the phase angle deviation still has a sawtooth-like profile, but the amplitude is no longer constant. The amplitude increases from a small amplitude of approximately π/2 in each case at the peripheries of the phase mask to a maximum of 2π at the centre. The result is that the proportion of the light that is diffracted into the first order is relatively large at the centre of the phase mask and relatively small at the peripheries. Inversely, the proportion of the light that passes through the phase mask without diffraction is comparatively high at the peripheries and comparatively low at the centre.

The situation that is the reverse of FIG. 7c) is illustrated in FIG. 7d). The amplitude of the sawtooth-like profile of the phase angle deviation increases from a low amplitude of approximately π/2 at the centre of the phase mask to a maximum amplitude of 2π in each case at the peripheries thereof. The result is that the proportion of the light that is diffracted into the first order is relatively large at the peripheries of the phase mask and relatively small at the centre. Inversely, the proportion of the light that passes through the phase mask without diffraction is comparatively high at the centre and comparatively low at the peripheries.

The substantial finding from this prior art is that both a desired intensity and an intensity profile can be set in a targeted manner with the aid of a controllable phase mask. This is what the present invention uses for the purpose of microscopy and in particular for light sheet microscopy.

This is explained with reference to FIGS. 8 to 11. FIGS. 8 to 10 in each case show the phase mask 80 that is controlled to form different phase patterns 73, 74 or 75. The phase patterns 73, 74 or 75 each have the chequerboard-like form as in FIG. 5. The phase angle deviation ω for which the second regions 72 are controlled should again correspond to the minimum phase angle deviation that is realizable by the phase mask 80, in particular, ω can be ω=0.

In the situation of FIG. 8, the phase angle deviation φ is constantly π everywhere. That means that the diffraction efficiency of the phase pattern 73 is at a maximum.

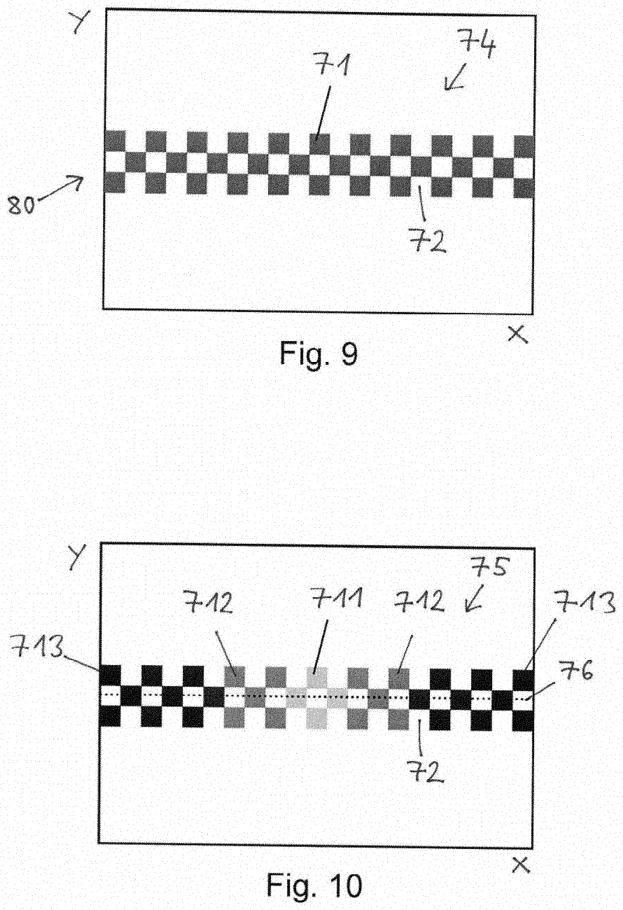

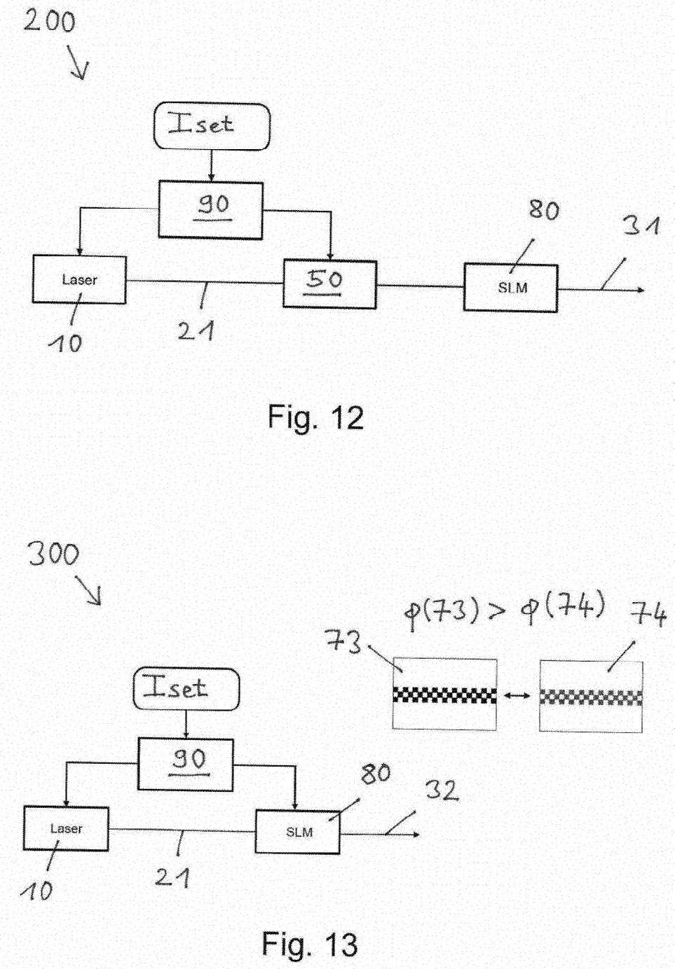

In the phase pattern 74 of FIG. 9, the phase angle deviation of the first regions is likewise constant everywhere, but is, for example, only π/2. As a result, the phase pattern 74 now only has a diffraction efficiency of 50% of the maximum value. This is used for the method according to the invention for varying the intensity of illumination light and for the apparatus according to the invention for providing illumination light with variable intensity. Further details in this respect will be described in connection with FIGS. 12 and 13.

FIG. 10 shows the phase mask 80 with a phase pattern 75, which can serve to compensate the intensity profile of Gaussian illumination and to consequently achieve an intensity of the illumination light that is constant over a cross-sectional area of a light sheet. For this purpose, the phase angle deviation φ in the phase pattern 75 of FIG. 10 is set in a spatially dependent manner, that is to say in dependence on the x-coordinate. This setting is effected qualitatively such that the diffraction efficiency is minimal at the centre of the phase mask 80, to which the maximum intensity of the Gaussian illumination profile is applied, that is to say at 711, and increases with the distance from the centre. The diffraction efficiency is thus maximal for the regions 713, and the diffraction efficiency of the regions 712 lies between the minimum at 711 at the centre and the maximum value at 713.

Consequently, it is the concept of the invention to control the phase mask to form a phase pattern with a spatially dependent phase angle deviation. At the periphery of the phase mask (regions 713), where illumination is weak, the phase pattern 75 has a phase shift of π and thus a maximum diffraction efficiency. At the centre of the phase mask 80 (region 711), where illumination is strong, a lower phase angle deviation is set and the diffraction efficiency is reduced. The spatially dependent phase angle deviation can be determined as follows:

φ(x)=φ₀(1−I(x)/Iₘₐₓ).

Here, φ(x) denotes the phase angle deviation for which a first region of the phase mask should be controlled at the location x of the phase mask, φ₀ is a specific fixed phase angle deviation, for example the maximum phase angle deviation that can be implemented with the phase mask, I(x) is the profile of the intensity of the illumination light in the plane of the phase mask at the location x, and Iₘₐₓ is the maximum intensity of the illumination light in the plane of the phase mask. By selecting the value φ₀, the maximum intensity can be determined.

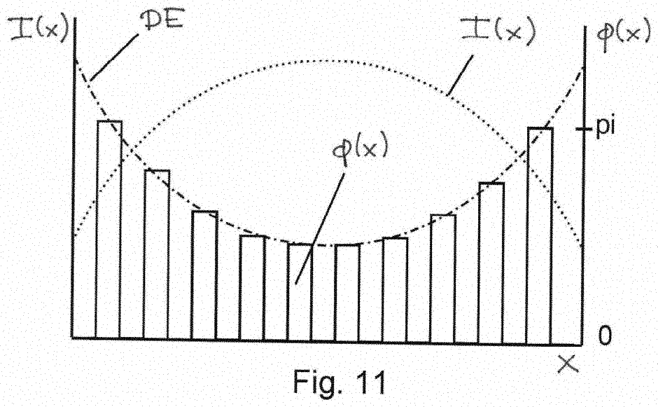

FIG. 11 shows a diagram illustrating the spatially dependent phase angle deviation φ(x) (solid lines), the illumination intensity I(x) (dotted line) from FIG. 3 and the diffraction efficiency DE (dash-dotted line) against the x-coordinate.

The statements made with respect to FIGS. 8 to 11 apply for the case that light diffracted into the first order of diffraction is used for generating the light sheet. In principle, non-diffracted light can also be used. That is to say that the diffraction efficiency does not need to be increased but reduced for increasing the intensity. To compensate the Gaussian illumination, the phase pattern would then have to be set such that the diffraction efficiency at the centre is at a maximum and is at a minimum at the peripheries.

It is thus possible with the spatially dependent setting of the phase angle deviation φ(x) according to the method of the present invention to achieve that the light sheet produced has a largely homogeneous intensity distribution over the entire field of view.

For the case that the detection objective exhibits vignetting, that is to say the image becomes darker towards the periphery even in the case of a homogeneous intensity distribution in the light sheet, this can be taken into account when adapting the spatially dependent phase angle deviation φ(x). In that case, the light sheet can be set such that it is no longer uniformly bright but is brighter at the periphery than it is at the centre. In this way, more fluorescence is excited at the periphery, and the vignetting of the detection objective can be compensated.

The present invention can also be applied in what is known as the “blazed grating method” described in Davis et al., Applied Optics Vol. 38, Issue 23, pp. 5004-5013 (1999). In particular, a light beam having a Gaussian profile, as is used in conventional light sheet microscopes, can be modulated in terms of the intensity in accordance with the method according to the invention.

The method according to the invention and the apparatus according to the invention for providing illumination light with variable intensity are explained with reference to FIGS. 12 and 13.

One problem is that the lasers that are able to be modulated directly, that is to say without the aid of a downstream AOTF, and are increasingly used for fluorescence microscopy cannot be finely set as desired in terms of their intensity due to their limited dynamic range. So if lasers having a high intensity are intended to be used, for example for experiments with photo switches, for example FRAP, PAINT, the intensity in such lasers for normal fluorescence microscopy can no longer be set sufficiently finely. That means that either acousto-optical elements need to be used again or interchangeable attenuators (neutral density filters) must be introduced into the beam path. This is not favourable due to the associated effort.

FIG. 12 shows an apparatus 200 for providing illumination light according to the prior art, which has, as essential components, a light source, in particular in laser 10, a device 50 for coarsely setting the intensity, for example a filter wheel with different attenuators (neutral density filters). Initially, a specific target value Iset of the intensity is input into the control unit 90. The control unit 90, which can control, for example, the intensity of the laser 10 over a dynamic range of from 10% to 100% of its maximum intensity, then positions, via the device 50, a suitable attenuator in the beam path and suitably sets the intensity of the laser 10 so that illumination light 31 having the desired intensity Iset is provided at an interface. The SLM present in FIG. 12 can serve for shaping a light sheet.

FIG. 13 shows a schematic illustration of an exemplary embodiment of an apparatus according to the invention for providing illumination light having an, in particular continuously, variable intensity. As compared to the prior art, the intensity is now set by controlling the phase mask 80 to form a phase pattern in dependence on the desired intensity. FIG. 13 schematically shows a phase pattern 73 with a maximum diffraction efficiency and a further phase pattern 74 having a reduced diffraction efficiency compared to the phase pattern 73. For the case that light of the first order of diffraction is used as the illumination light, a higher intensity of the illumination light 32 is consequently achieved if the phase mask 80 is controlled by the phase pattern 73 as compared to the situation in which the phase mask is controlled by the phase pattern 74. If light of the zero order of diffraction is used as the illumination light, the situation is reversed, that is to say the phase pattern 74 would achieve a higher intensity compared to the phase pattern 73.

It is essential that the controller 90 converts a desired intensity value Iset to be input into a suitable setting of a phase pattern of the phase mask 80 with the result that illumination light 32 having the desired intensity is provided. The intensity of the illumination light 32 can in principle be set continuously due to the analogue properties of the phase mask used. However, in practical terms, the phase mask replaces the coarse setting and reduces for example the intensity by a factor of 0.1, and the actual fine setting is performed by way of the laser.

The solution according to the invention is thus the reduction of the diffraction efficiency of the respectively used phase pattern as before by reducing the phase angle deviation, for example to π/2. As a result, the phase pattern 74 then only has a diffraction efficiency of 50% compared to the phase pattern 73. That is to say, the phase angle deviation is not set in a spatially dependent manner, but the diffraction efficiency is either reduced or increased globally so as to be able to finely, in particular continuously, set even low intensities of the illumination light, in particular low intensities of a light sheet, with a limited dynamic range of a laser or of a plurality of lasers. The phase mask 80 thus becomes part of the control loop of the illumination intensity, in particular the intensity of a light sheet.

### LIST OF REFERENCE SIGNS

2 Illumination objective
3 Microscope, microscope objective, illumination objective
4 Sample plane
5 Sample
6 Light sheet
7 Sample vessel, petri dish
8 Liquid in sample vessel 7
10 Light source, laser
20 Beam shaping unit, illumination unit
21 Incoming beam bundle, in particular Gaussian beam
22 First lens, for example cylindrical lens
23 Second lens, for example cylindrical lens
24 Third lens
25 Pinhole stop
26 Fourth lens
27 Plane that is optically conjugate to the plane of the phase mask 80
28 Schematically illustrated distribution of the intensity of the illumination light on the phase mask 80
40 Observation optical unit and camera
31 Illumination light
32 Illumination light
50 Device for coarsely setting the intensity, for example filter wheel having different attenuators
70 Phase pattern
71 First regions
72 Second regions
73 Second phase pattern
74 Third phase pattern
75 Fourth phase pattern
76 Axis of symmetry of the phase pattern 70/of the phase mask 80
80 Phase mask
90 Control unit
100 Apparatus for light sheet microscopy (prior art)
200 Apparatus for providing illumination light (prior art)
300 Apparatus for providing illumination light with continuously settable intensity
711 First region
712 First region
713 First region
A1 Optical axis of the illumination objective 2
A2 Optical axis of the microscope objective 3
BE Observation plane
DE Diffraction efficiency
I(x) Intensity of the illumination light at the location of the phase mask 80
α1 Angle between the axis A1 and the surface normal of the sample plane 4
α2 Angle between the axis A2 and the surface normal of the sample plane 4
φ(x) Phase angle deviation of the first regions
ω Phase angle deviation of the second regions

What is claimed is:

1. Method for light sheet microscopy,
in which a sample is illuminated with a light sheet and is observed using a microscope,
wherein illumination light is shaped to form the light sheet using a controllable phase mask,
wherein the controllable phase mask is controlled to form a phase pattern, in which at least first regions and second regions are arranged in alternation, and wherein a greater phase angle deviation is impressed on the illumination light in the first regions than in the second regions,
wherein
in that, for influencing the intensity of the illumination light at different locations of a cross-sectional area of the light sheet, at least the phase angle deviation of the first regions is controlled in a spatially dependent manner.

2. Method according to claim 1,
wherein the intensity of the illumination light at different locations of a cross-sectional area of the light sheet is homogenized.

3. Method according to claim 1,
wherein,
for varying a desired intensity of the illumination light downstream of the controllable phase mask, at least the phase angle deviation of the first regions is controlled depending on the desired intensity.

4. Method according to claim 1,
wherein
the first regions and second regions are arranged in a chequerboard-like manner.

5. Method according to claim 1,
wherein
the phase angle deviation of the first regions is greater than π/2, and
the phase angle deviation of the second regions is smaller than π/2.

6. Method according to claim 1,
wherein
the phase angle deviation of the second regions is constant.

7. Method according to claim 1,
wherein
the phase angle deviation of the second regions corresponds to a minimal phase angle deviation, which can be realized by way of the controllable phase mask.

8. Method according to claim 1,
wherein
the phase angle deviation of the first regions is set in a spatially dependent manner such that the intensity of the illumination light is substantially constant over a cross-sectional area of the light sheet.

9. Method according to claim 1,
wherein
the spatially dependent phase angle deviation φ(x) of the first regions is given by φ(x)=φ₀(1−I(x)/Iₘₐₓ).

10. Method according to claim 1,
wherein
the phase angle deviation of the first regions is set in a spatially dependent manner such that the intensity of the illumination light in the cross-sectional area of the light sheet increases with the distance from the optical axis of an observation optical unit.

11. Method according to claim 1,
wherein
the controllable phase mask has the shape of a long rectangle, and
the spatially dependent phase angle deviation along the direction of the longer side of the rectangle relative to the centre is a symmetric function.

12. Method according to claim 1,
wherein
the phase pattern that the controllable phase mask is controlled to form is periodic at least in one spatial direction.

13. Apparatus for light sheet microscopy,
having a light source for providing illumination light,
having a controllable phase mask and further optical components for shaping the light sheet,
having optical components, in particular an objective, for guiding the light sheet into a sample,
having a microscope for observing the sample, and
having a control device for controlling the phase mask,
wherein
the control device is configured for controlling the phase mask in accordance with the method according to one of claim 1.

14. Apparatus according to claim 13,
wherein
the phase mask is a 2D phase mask with pixel rows and pixel columns.

15. Apparatus according to claim 13,
wherein
the phase mask is a nematic spatial light modulator (SLM) or a ferroelectric spatial light modulator (SLM).

16. Apparatus according to claim 13,
wherein
the light source is a laser having a settable intensity.

17. Apparatus according to claim 13,
wherein
the microscope is a laser scanning microscope or a widefield microscope.

18. Method for varying an intensity of illumination light,
in which illumination light is guided over a controllable phase mask,
wherein the controllable phase mask is controlled to form a phase pattern, in which at least first regions and second regions are arranged in alternation, and
wherein a greater phase angle deviation is impressed on the illumination light in the first regions than in the second regions,
wherein,
for varying a desired intensity of the illumination light downstream of the controllable phase mask, at least the phase angle deviation of the first regions is controlled depending on the desired intensity.

19. Method according to claim 18,
wherein
the first regions and second regions are arranged in a chequerboard-like manner.

20. Method according to claim 18,
wherein
the phase angle deviation of the first regions is greater than π/2, and
the phase angle deviation of the second regions is smaller than πb 2.

21. Method according to claim 18,
wherein
the phase angle deviation of the second regions is constant.

22. Method according to claim 18,
wherein
the phase angle deviation of the second regions corresponds to a minimal phase angle deviation, which can be realized by way of the controllable phase mask.

23. Method according to claim 18,
wherein
the phase angle deviation of the first regions is set in a spatially dependent manner such that the intensity of the illumination light is substantially constant over a cross-sectional area of the light sheet.

24. Method according to claims 18,
wherein
the spatially dependent phase angle deviation φ(x) of the first regions is given by φ(x)=φ₀(1−I(x)/Iₘₐₓ).

25. Method according to claims 18,
wherein
the phase angle deviation of the first regions is set in a spatially dependent manner such that the intensity of the illumination light in the cross-sectional area of the light sheet increases with the distance from the optical axis of an observation optical unit.

26. Method according to claim 18,
wherein
the controllable phase mask has the shape of a long rectangle, and
the spatially dependent phase angle deviation along the direction of the longer side of the rectangle relative to the centre is a symmetric function.

27. Method according to claim 18,
wherein
the phase pattern that the controllable phase mask is controlled to form is periodic at least in one spatial direction.

28. Apparatus for providing illumination light with, in particular continuously, variable intensity,
having a light source for providing illumination light,
having a controllable phase mask,
having a control unit for controlling the phase mask,
wherein
the control unit is configured for controlling the phase mask in accordance with the method according to claim 18.

29. Apparatus according to claim 28,
wherein
the phase mask is a 2D phase mask with pixel rows and pixel columns.

30. Apparatus according to claim 28,
wherein
the phase mask is a nematic spatial light modulator (SLM) or a ferroelectric spatial light modulator (SLM).

31. Apparatus according to claim 28,
wherein
the light source is a laser having a settable intensity.
